(19) United States
(12) Patent Application Publication
(10) Pub. No.: US 2011/0063959 A1
(43) Pub. Date: Mar. 17, 2011

(54) LOADER MODULE OF AN OPTICAL ACCESS APPARATUS

(76) Inventors: Chien Yi Huang, Taipei County (TW); Cheng Li Chang, Taipei County (TW)

(21) Appl. No.: 12/725,784

(22) Filed: Mar. 17, 2010

(30) Foreign Application Priority Data
Sep. 16, 2009 (TW) 098217073

(51) Int. Cl. G11B 20/00

(52) U.S. Cl. 369/47.15; G9B/20

(57) ABSTRACT

A loader module of an optical access apparatus is provided. The optical access apparatus has a main control printed circuit board (PCB). The loader module comprises an optical pick-up head, a drive unit, a first signal line, a second signal line and a non-volatile memory (NVM). The first signal line is configured to electrically connect the optical pick-up head, the drive unit and the main control PCB. The second signal line is configured to electrically connect the NVM and the main control PCB. The NVM is configured to store control information. The control information is transmitted to the main control PCB via the second signal line so that the main control PCB can control the loader module.

This application claims the benefit from the priority to Taiwan Patent Application No. 098217073 filed on Sep. 16, 2009, the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to a loader module. More specifically, the present invention relates to a loader module of an optical access apparatus.

2. Descriptions of the Related Art

The optical access apparatuses that are currently available on the market (such as optical disc drives, DVD optical disc drives, and Blu-ray optical disc drives) comprise both a control printed circuit board (PCB) and a loader system. The optical access apparatus manufacturer generally needs to perform a calibration test on the loader system of the optical access apparatus in the course of manufacturing the optical access apparatus to ensure stability of the optical access apparatus in writing/burning information. The main purpose of the calibration test is to record laser power calibration information of the optical pick-up head of the loader system while the optical access apparatus is writing/burning information. Afterward, the optical access apparatus manufacturer stores the laser power calibration information in a memory of the control printed circuit board of the optical access apparatus.

Thus, when the consumer uses the above-mentioned optical access apparatus in writing/burning information, the loader system will read the laser power calibration information stored in the memory via the control printed circuit board, and will be optimally adjusted in accordance with different types/quality optical storage media (such as optical disc, DVD, Blu-ray disc, etc.), so that the rate of failure in writing/burning information is reduced.

However, different optical access apparatus manufacturers have different types of requirements for the control printed circuit board of the optical access apparatus, thus, manufacturers usually purchase the above-mentioned loader system only, and then the control printed circuit board of the optical access apparatus is specially customized based on the manufacturer's requirements. Accordingly, optical access apparatus manufacturers need to make large investments and expend labor to proceed with the calibration of the optical pick-up head of the loader system on their own. As a result, the testing time and manufacturing costs are increased.

In addition, even if optical access apparatus manufacturers purchase both the above-mentioned control printed circuit boards and loader systems for manufacturing to optical access apparatus, the manufacturers still have to modify, purchase or configure additional components to the control printed circuit board if the control printed circuit board does not fulfill the function thereof. Thus, the cost of labor and investment is increased.

Accordingly, the objective of the present invention is to improve the manufacturing process of an optical access apparatus, and reducing the test time, overall cost of production and the waste of resources.

### SUMMARY OF THE INVENTION

To overcome the above-mentioned drawbacks, an objective of the present invention is to provide a loader module of an optical access apparatus. The optical access apparatus has a main control printed circuit board (PCB). The loader module comprises an optical pick-up head, a drive unit, a first signal line, a second signal line and a non-volatile memory (NVM) (for instance, ROM, EPROM, EEPROM, FLASH). The first signal line is configured to electrically connect the optical pick-up head, the drive unit and the main control PCB. The second signal line is configured to electrically connect the NVM and the main control PCB. The NVM is configured to store control information, and the control information comprises data format calculation information, pick-up head control information, drive unit control information, motor control information and switch detection information, which can be used to control the actions of the optical access apparatus. The control information is transmitted to the main control PCB via the second signal line so that the main control PCB controls the operation of the loader module according to the control information via the first signal line. The pick-up head control information is transmitted to the main control PCB via the second signal lines so that the main control PCB operates the optical pick-up head according to the pick-up head control information via the first signal line. The drive unit control information is transmitted to the main control PCB by the second signal line so that the main control PCB controls the drive unit according to the drive unit control information via the first signal line.

Another objective of the present invention is to provide an optical access apparatus. The optical access apparatus comprises a main control printed circuit board (PCB), at least one first signal line, a second signal line, a switch circuit, a non-volatile memory (NVM) and a loader module. The loader module further comprises an optical pick-up head and a drive unit. The optical pick-up head, the drive unit and the main control PCB are electrically connected via the at least one first signal line. The NVM and the main control PCB are electrically connected via the second signal line. The switch circuit is configured to control a status of the optical access apparatus. The NVM is configured to store control information, and the control information comprises data format calculation information, pick-up head control information, drive unit control information, motor control information and switch detection information, which can be used to control the actions of the optical access apparatus. The control information is transmitted to the main control PCB via the second signal line so that the main control PCB controls the operation of the loader module according to the control information via the at least one first signal line. The pick-up head control information is transmitted to the main control PCB via the second signal lines so that the main control PCB operates the optical pick-up head according to the pick-up head control information via the at least one first signal line. The drive unit control information is transmitted to the main control PCB via the second signal line so that the main control PCB controls the drive unit according to the drive unit control information via the at least one first signal line.

In view of the above, the loader module of an optical access apparatus of the present invention can be manufactured separately from the main control PCB used in the optical access apparatus. In addition, the loader module, in the initial stage of manufacturing, is calibrated by the manufacturer of the loader module. Thus, the manufacturer of optical access apparatus need not require investing additional testing time and testing capital in the loader module calibration. At the same time, the manufacturer of optical access apparatus can manufacture the main control PCB in accordance with the requirements of the manufacturer. With the framework of the present invention, module manufacturers only need to assemble the internal components of the module and does not require special technology in the manufacturing process. Therefore, the manufacturing procedures of optical access apparatuses are simplified and the production cost is greatly reduced.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram illustrating a first embodiment of the present invention;

FIG. 2 is a schematic diagram illustrating a second embodiment of the present invention; and

FIG. 3 is a schematic diagram illustrating a third embodiment of the present invention.

### DESCRIPTION OF THE PREFERRED EMBODIMENT

References will be made to the embodiments of the invention, examples of which are illustrative and not limiting. These embodiments illustrate drawings with omitted non-directly related components and it should be understood that the dimension of the individual components is merely for the understanding of the invention and is not intended so limit the actual dimension thereof.

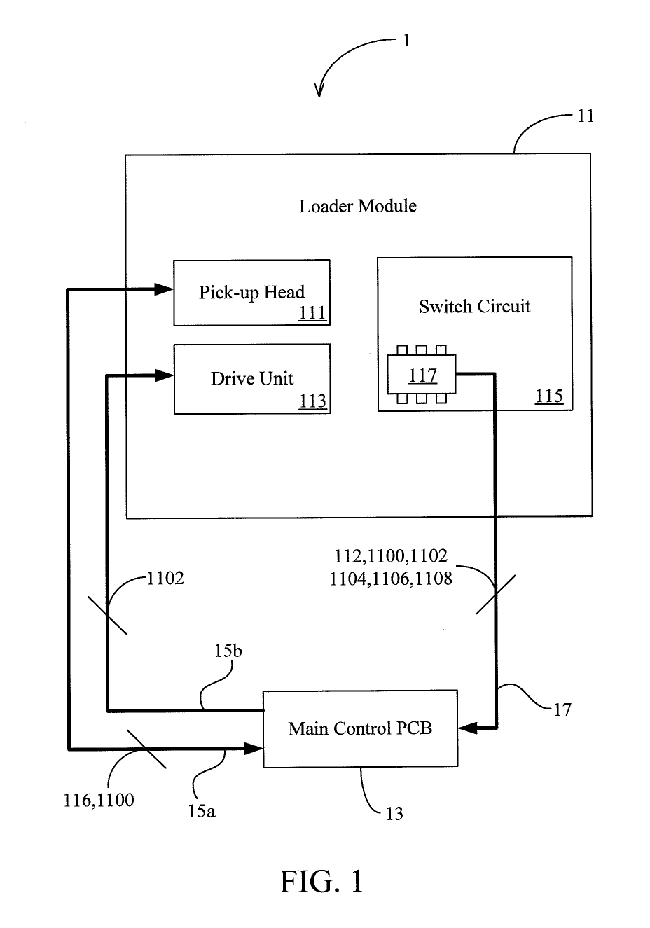

FIG. 1 illustrates a first embodiment of the present invention, which is a loader module 11 of an optical access apparatus 1. The optical access apparatus 1 can be CD-ROM, DVD-ROM, Blu-ray, ROM or optical disc burner with data-write function and its derivative of optical disc access apparatus, which comprises a loader module 11, a main control printed circuit board (PCB) 13, two first signal lines 15a, 15b and a second signal line 17. The loader module 11 comprises an optical pick-up head 111, a drive unit 113, a switch circuit 115 and a non-volatile memory (NVM) 117.

NVM 117 can be a flash memory or a carrier with information storage capability, and it is disposed within the switch circuit 115. The first signal lines 15a, 15b and the second signal line 17 can be a flexible flat cable (FFC) or a flexible printed circuit (FPC). The components mentioned above which are adapted for NVM 117, the first signal lines 15a; 15b and the second signal line 17 are not used to limit the present invention. Those skilled in the art will recognize that various modifications may be provided by replacing components with similar functions, thus it will not be further described hereinafter.

In accordance with the present invention, the manufacturing of optical access apparatus 1 can be divided into two different stages, i.e., the first stage is about the loader module 11 and the second stage is about the connection between the loader module 11 and the main control PCB 13.

In more detail, during the first stage, different types/quality optical storage media (such as optical disc, DVD optical disc, Blu-ray optical disc) are first subjected to information-reading/information-writing optimization tests by the manufacturer of the loader module. After that, based on the result of the optimization test, control information is obtained and is stored in the NVM 117.

The control information comprises pick-up head control information 1100 related to the optical pick-up head 111, drive unit control information 1102 related to the drive unit 113, data format calculation information 1104, motor control information 1106 and switch detection information 1108. It should be noted that the pick-up head control information 1100, the drive unit control information 1102, the motor control information 1106 and the switch detection information 1108 comprised in the control information 1100 are control-related information generated for the operating hardware.

After the loader module 11 has converted the optical analog signal into the logic signal, the data format calculation information 1104 is used to process the above-mentioned logic signal. The rear modules (not shown) at the rear end of the optical access apparatus 1 receive the logic signal which has been processed by the data format calculation information 1104, and the logic signal is then processed.

Afterwards, during the second stage, the manufacturer of the optical access apparatus can manufacture the main control PCB 13 to fulfill requirements. The main control PCB 13 and the optical pick-up head 111 are electrically connected to each other via the first signal line 15a. The main control PCB 13 and the drive unit 113 are electrically connected to each other via the first signal line 15b. The main control PCB 13 and the NVM 117 are electrically connected to each other via the second signal line 17.

The main control PCB 13 reads the control information, which is pre-stored in the NVM 117, via the second signal line 17. In other words, the pick-up head control information 1100, the drive unit control information 1102, the data format calculation information 1104, the motor control information 1106 and the switch detection information 1108, which are included in the control information, are transmitted to the main control PCB 13 via the second signal line 17 as well. Next, the main PCB 13 reads the pick-up head control information 1100 stored in the NVM 117 to operate the optical pick-up head 11 via the first signal line 15a. At the same time, the main control PCB 13 reads the drive unit control information 1102 stored in the NVM 117 via another first signal line 15b to proceed with process control on the drive unit 113.

In other words, in view of the above mentioned contents, the main control PCB 13 proceeds with the related control on the loader module 11 according to the control information via the first signal lines 15a, 15b. Hence, the optical access apparatus 1 can make use of different types or quality optical storage media (such as optical disc, DVD optical disc, Blu-ray optical disc, etc) to read/write information. Accordingly, the rate of failure of reading/writing information is reduced.

In particular, the afore-mentioned method of electrically connecting the optical pick-up head 111 and the drive unit 113 via the first signal lines 15a, 15b, respectively, is not limited to the present invention. Those skilled in the art can easily make use of a single line to simultaneously and electrically connect the optical pick-up head 111 and the drive unit 113. At the same time, the single line delivers in parallel and/or in sequence to the pick-up head control information 1100 and the drive unit control information 1102. Thus, further description is omitted.

Furthermore, when optical access apparatus manufacturers want to apply the loader module 11 in the optical access apparatus 1 with the function of reading/writing Blu-ray disc, a Advanced Access Content System Key (AASC Key) 114 required in Blu-ray disc is first stored in the NVM 117. If the optical access apparatus 1 needs to decode information by the AASC key 114 when reading Blue-ray discs, the main control PCB 13 only needs to read the AASC key 114 stored in the NVM 117 via the second signal line 17 to decode the Blu-ray disc information 116 transmitted from the optical pick-up head 111.

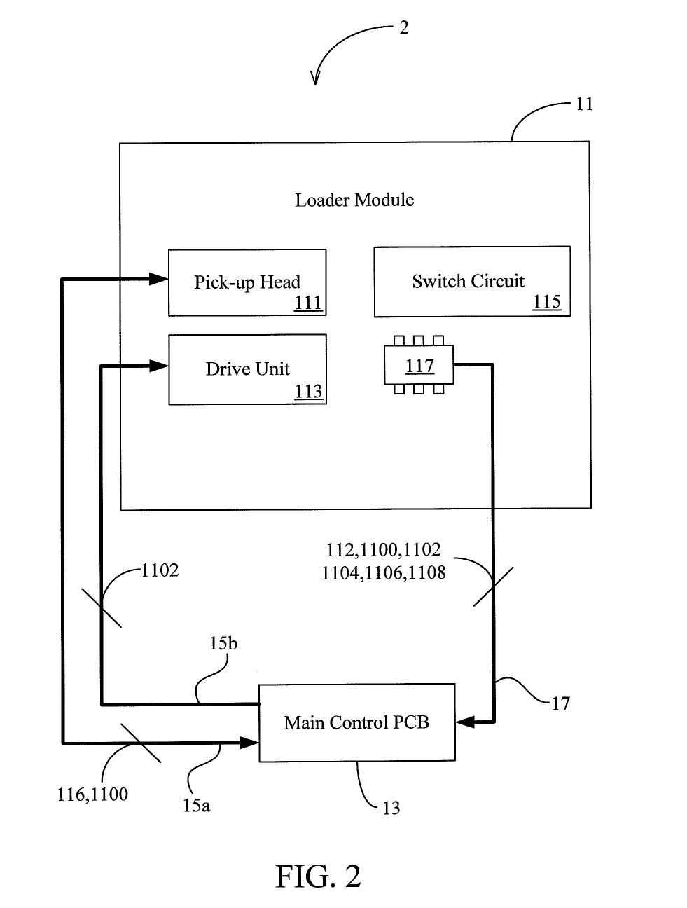

It should be appreciated that the present invention does not restrict the position of the NVM 117 in the optical access apparatus 1. FIG. 2 illustrates a second embodiment of the present invention. It should be understood that the function and operation of the components with identical reference numbers for the optical access apparatus 2 shown in FIG. 2 and the optical access apparatus 1 shown in FIG. 1 are the same, therefore, further description is omitted. The difference between the first embodiment and the second embodiment is that the NVM 117 of the optical access apparatus 2 of the second embodiment is mounted alone with the loader module 11 but not with the switch circuit 115. As a result, the configuration of the components of the loader module 11 has a greater flexibility so that the optical access apparatus manufacturers can retrieve a better configuration of the loader module 11 within the optical access apparatus. In other words, optical access apparatus manufacturers can dispose the NVM 117 alone at any optional position within the loader module 11, at the same time, the loader module 11 can be further adjusted in accordance with the dimension of the optical access apparatus.

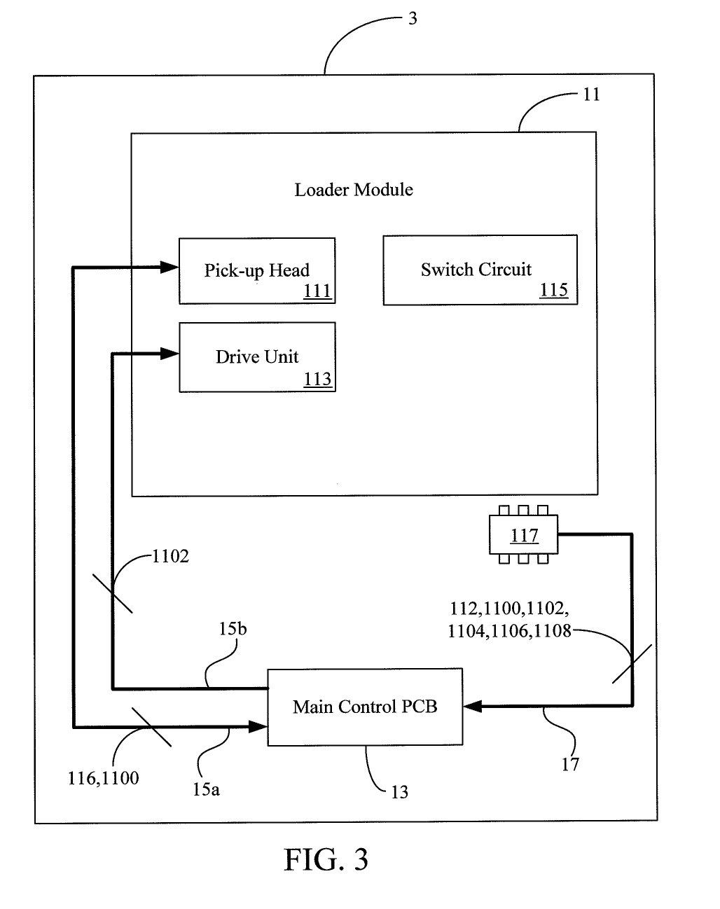

Furthermore, FIG. 3 illustrates a third embodiment of the present invention. It should be understood that the functions and operations of the components with identical reference numbers for the optical access apparatus 3 shown in FIG. 3 and the optical access apparatus 1 shown in FIG. 1 are the same in the first preferred embodiment; therefore, further description is therefore omitted. In view of the contents shown in FIG. 3, the difference between the third embodiment and the second embodiment is that the NVM 117 of the optical access apparatus 3 does not need to be disposed on the loader module 11 or the switch circuit 115 of the loader module 11. In other words, as long as the NVM 117 electrically connects correctly to the main control PCB 13 via the second signal line 17, then the position of the NVM 117 in the optical access apparatus 3 is not restricted.

In view of the above, the calibration information does not need to be stored in the control PCB based on the present invention. Accordingly, extra costs of calibration testing are eliminated when the optical disc drive manufactures want to produce the PCB on their own. Furthermore, the waste of spare material when producing the components can be reduced as well. Accordingly, the present invention simplifies the subsequent production procedure to reduce the capital and also mitigates the above-mentioned drawbacks.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A loader module of an optical access apparatus, the optical access apparatus having a main control printed circuit board (PCB), at least one first signal line and a second signal line, the loader module comprising:
an optical pick-up head;
a drive unit; and
a non-volatile memory (NVM) being configured to store control information;
wherein the optical pick-up head, the drive unit and the main control PCB are electrically connected via the at least one first signal line;
wherein the NVM and the main control PCM are electrically connected via the second signal line; and
wherein the main control PCB controls the loader module according to the control information stored in the NVM via the at least one first signal line.

2. The loader module as claimed in claim 1, wherein the control information comprises data format calculation information, pick-up head control information, drive unit control information, motor control information, and a switch detection information.

3. The loader module as claimed in claim 2, wherein the main control PCB respectively controls the optical pick-up head and the drive unit according to the pick-up head control information and the drive unit control information stored in the NVM via the at least one first signal line.

4. The loader module as claimed in claim 1, further comprising a switch circuit being configured to control a status of the optical access apparatus.

5. The loader module as claimed in claim 4, wherein the NVM is disposed on the switch circuit.

6. The loader module as claimed in claim 1, wherein the NVM further stores an advance access content system (AASC) key.

7. The loader module as claimed in claim 6, wherein the optical access apparatus is a blue-ray optical disc drive.

8. The loader module as claimed in claim 1, wherein the NVM is a flash memory.

9. The loader modules as claimed in claim 1, wherein the second signal line is a flexible flat cable (FFC).

10. The loader module as claimed in claim 1, wherein the second signal line is a flexible printed circuit (FPC).

11. An optical access apparatus, comprising:
a main control printed circuit board (PCB);
at least one first signal line;
a second signal line;
a switch circuit being configured to control a status of the optical access apparatus;
a non-volatile memory (NVM) being configured to store control information; and
a loader module, comprising:
an optical pick-up head; and
a drive unit;
wherein the optical pick-up head, the drive unit and the main control PCB are electrically connected via the at least one first signal line;
wherein the NVM and the main control PCB are electrically connected via the second signal line; and
wherein the main control PCB controls the loader module according to the control information stored in the NVM via the at least one first signal line.

12. The optical access apparatus as claimed in claim 11, wherein the control information comprises data format calculation information, pick-up head control information, drive unit control information, motor control information, and switch detection information.

13. The optical access apparatus as claimed in claim 12, wherein the main control PCB respectively controls the optical pick-up head and the drive unit according to the pick-up head control information and the drive unit control information stored in the NVM via the at least one first signal line.

14. The optical access apparatus as claimed in claim 11, wherein the NVM further stores an advance access content system (AASC) key.

15. The optical access apparatus as claimed in claim 14, wherein the optical access apparatus is a blue-ray optical disc drive.

16. The optical access apparatus as claimed in claim 11, wherein the NVM is a flash memory.

17. The optical access apparatus as claimed in claim 11, wherein the second signal line is a flexible flat cable (FFC).

18. The optical access apparatus as claimed in claim 11, wherein the second signal line is a flexible printed circuit (FPC).
